(19) United States
(12) Patent Application Publication
(10) Pub. No.: US 2008/0173790 A1
(43) Pub. Date: Jul. 24, 2008

(54) Motion-detecting module with a built-in light source

(75) Inventors: Chia-Chu Cheng, Hsin-Tien City (TW); Jau-Yu Chen, Hsin-Tien City (TW); Shih-Heng Lin, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(73) Assignee: LITE-ON SEMICONDUCTOR CORP.

(21) Appl. No.: 11/802,185

(22) Filed: May 21, 2007

(30) Foreign Application Priority Data
Jan. 18, 2007 (TW) 96200938

(51) Int. Cl. G01V 8/14

(52) U.S. Cl. 250/206; 250/222.1

(57) ABSTRACT

A motion-detecting module with a built-in light source includes a chip unit, a cover unit, and a light-guiding unit. The chip unit has a PCB, a light-emitting chip, and an image-sensing chip. The light-emitting chip and the image-sensing chip are electrically disposed on the PCB. The cover unit is covered on the image-sensing chip, and the cover unit has a first opening for exposing the image-sensing chip. The light-guiding unit is disposed on a bottom side of the cover unit, and the light-guiding unit has a surface having a reflective layer thereon with a concave structure. The surface and the reflective layer are formed a reflective surface for reflecting and condensing beams generated from the light-emitting chip. Therefore, the beams are reflected via the reflective surface to form first beams, and the first beams are reflected via the object surface to form second beams that project onto the image-sensing chip.

### BACKGROUND OF THE INVENTION

1. Field of the Invention

The present invention relates to a motion-detecting module, and particularly relates to a motion-detecting module with a built-in light source.

2. Description of the Related Art

FIG. 1 shows a cross-sectional, schematic view of an image-sensing device of the prior art. The image-sensing device of the prior art includes a main PCB (Printed Circuit Board) 1a, a light-emitting element 2a, an illuminant-fixing mechanism 3, an image-sensing element 4a, and a package casing 5a.

The light-emitting element 2a is fixed on the illuminant-fixing mechanism 3 and is electrically connected with the main PCB 1a via a leading wire 20a. Moreover, the image-sensing element 4a is disposed on the main PCB 1a and is electrically connected with the main PCB 1a via a plurality of leading wire 40a. Furthermore, the package casing 5a covers on the image-sensing element 4a and has an opening hole 50a for exposing the image-sensing element 4a. Therefore, the light-emitting element 2a generates a beam B1 onto an object surface S to form a reflective beam B2, and the reflective beam B2 is projected onto the image-sensing element 4a through the opening hole 50a for sensing the image of the object surface S.

However, the light-emitting element 2a and the image-sensing element 4a are separated from each other. Due to this kind of motion detecting module is a highly precise optical system, the relationship between the light-emitting element 2a and the image-sensing element 4a needs to be adjusted accurately so that the image-sensing element 4a can accurately sense the reflective beam B2. In other words, it is critical to align the light-emitting element 2a and the image-sensing element 4a on the main PCB 1a. Hence, the prior art is complex in both manufacturing process and assembling process. Besides, the illuminant-fixing mechanism 3 and the package casing 5a are separated from each other, so that the manufacturing cost of the prior art would be increased.

### SUMMARY OF THE INVENTION

One particular aspect of the present invention is to provide a motion-detecting module with a built-in light source. The motion-detecting module has a light-emitting chip and an image-sensing chip separately embedded in the same PCB (Printed Circuit Board). Moreover, the present invention uses a reflection type light-guiding element or a total internal reflection type light-guiding element for guiding beams from the light-emitting chip to the image-sensing chip.

In order to achieve the above-mentioned aspects, the present invention provides a motion-detecting module with a built-in light source, comprising a chip unit, a cover unit, and a light-guiding unit. The chip unit has a PCB, a light-emitting chip, and an image-sensing chip. Both the light-emitting chip and the image-sensing chip are electrically disposed on the PCB, respectively. The cover unit is covered on the image-sensing chip, and the cover unit has a first opening for exposing the image-sensing chip. The light-guiding unit is disposed on a bottom side of the cover unit, and the light-guiding unit has a reflective layer for reflecting and condensing beams that generate from the light-emitting chip. The light-guiding unit is a reflection type light-guiding element. Moreover, the reflective layer is a reflective material that is coated or pasted on a reflective surface with a concave structure of the light-guiding unit.

Therefore, the beams are reflected via the reflective layer on the reflective surface to form first beams that project onto an object surface, and the first beams are reflected via the object surface to form second beams that project onto the image-sensing chip.

In order to achieve the above-mentioned aspects, the present invention provides a motion-detecting module with a built-in light source, comprising a chip unit, a cover unit, and a light-guiding unit. The chip unit has a PCB, a light-emitting chip, and an image-sensing chip. Both the light-emitting chip and the image-sensing chip are electrically disposed on the PCB, respectively. The cover unit is covered on the image-sensing chip, and the cover unit has a first opening for exposing the image-sensing chip. The light-guiding unit is disposed on a bottom side of the cover unit, and the light-guiding unit has a reflective surface with a concave structure for reflecting and condensing beams that generate from the light-emitting chip. The light-guiding unit is a total internal reflection type light-guiding element. Moreover, the total internal reflection type light-guiding element has a refractive index higher than that of air.

Therefore, the beams are reflected via the reflective surface to form first beams that project onto an object surface, and the first beams are reflected via the object surface to form second beams that project onto the image-sensing chip.

Hence, the light-emitting chip and the image-sensing chip are separately embedded in the same PCB and the present invention uses the reflection type light-guiding element or the total internal reflection type light-guiding element for guiding beams from the light-emitting chip to the image-sensing chip, so that the manufacturing cost is reduced and the assembling yield is increased in the present invention.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a cross-sectional, schematic view of an image-sensing device of the prior art;

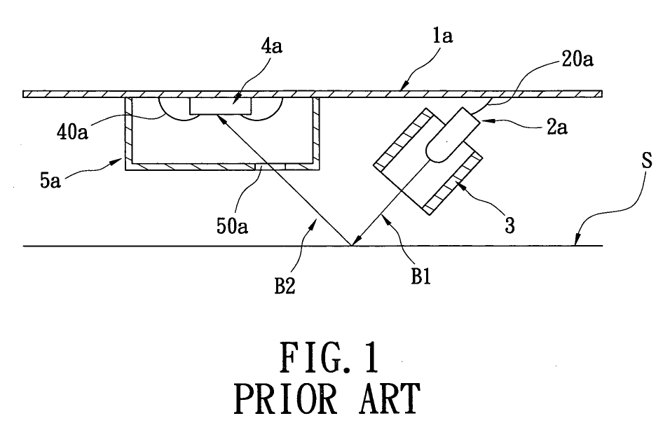

FIG. 2 is a cross-sectional, schematic view of a motion-detecting module with a built-in light source according to the first embodiment of the present invention;

FIG. 3 is a perspective view of a light-guiding unit according to the first embodiment of the present invention;

FIG. 4 is a cross-sectional, schematic view of a motion-detecting module with a built-in light source according to the second embodiment of the present invention;

FIG. 5 is a cross-sectional, schematic view of a motion-detecting module with a built-in light source according to the third embodiment of the present invention;

FIG. 6 is a perspective view of a light-guiding unit according to the third embodiment of the present invention;

FIG. 7 is a cross-sectional, schematic view of a motion-detecting module with a built-in light source according to the fourth embodiment of the present invention;

FIG. 8 is a cross-sectional, schematic view of another cover unit of the present invention;

FIG. 9 is a cross-sectional, schematic view of another cover unit of the present invention;

FIG. 10 is an explode, schematic view of a first conductive connection method between a chip unit and a main PCB according to the present invention;

FIG. 11 is an explode, schematic view of a second conductive connection method between a chip unit and a main PCB according to the present invention; and

FIG. 12 is an explode, schematic view of a third conductive connection method between a chip unit and a main PCB according to the present invention.

### DETAILED DESCRIPTION OF THE PREFERRED EMBODIMENTS

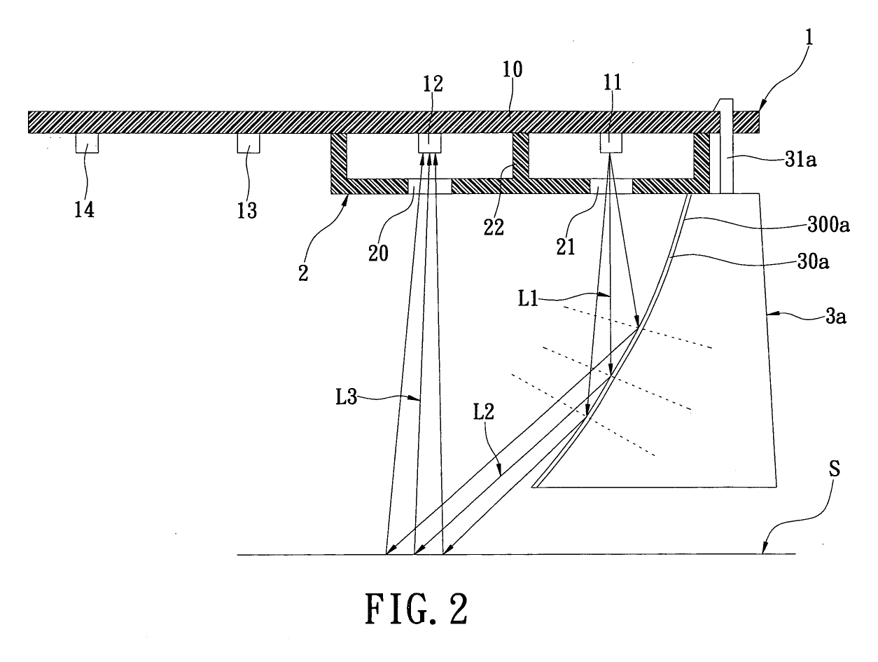

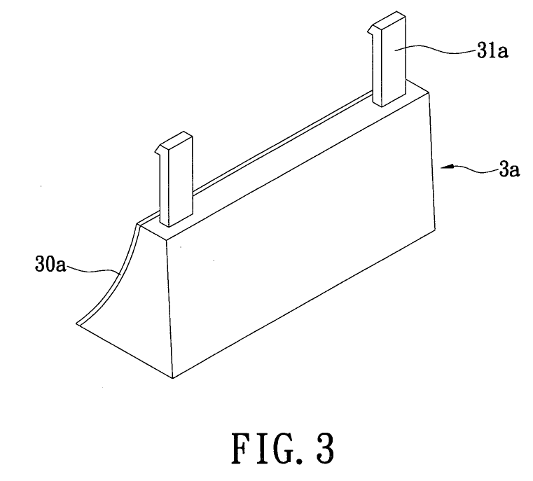

Referring to FIGS. 2 and 3, the first embodiment of the present invention provides a motion-detecting module with a built-in light source, comprising a chip unit 1, a cover unit 2, and a light-guiding unit 3a.

The chip unit 1 has a PCB (Printed Circuit Board) 10, a light-emitting chip 11, an image-sensing chip 12, a motion calculator ASIC (Application Specific Integrated Circuit) 13, and an interfacing MCU (Microprocessor Control Unit) 14 for communicating with external systems (not shown). The light-emitting chip 11, the image-sensing chip 12, the motion calculator ASIC 13, and an interfacing MCU 14 are electrically disposed on the PCB 10, respectively.

Moreover, the cover unit 2 is covered on the light-emitting chip 11 and the image-sensing chip 12. The cover unit 2 has a first opening 20 for exposing the image-sensing chip 12 and a second opening 21 for exposing the light-emitting chip 11.

Furthermore, the cover unit 2 has a partition 22 for dividing the light-emitting chip 11 from the image-sensing chip 12, in order to avoid light source from the light-emitting chip 11 to affect the image-sensing chip 12. The cover unit 2 is positioned on the PCB 10 of the chip unit 1.

According to the first embodiment, the light-guiding unit 3a is a reflection type light-guiding element. The light-guiding unit 3a has a reflective layer 30a for reflecting and condensing beams L1 that generate from the light-emitting chip 11, and the reflective layer 30a is a reflective material that is coated or pasted on a surface 300a of the light-guiding unit 3a. The reflective layer 30a and the surface 300a are formed as a reflective surface. The surface 300a is a concave structure. According to different requirements, the surface 300a can be a spherical surface, an aspherical surface, a paraboloid, a hyperboloid, or an ellipsoid.

Moreover, the light-guiding unit 3a is disposed on a bottom side of the cover unit 2. The light-guiding unit 3a has a plurality of positioning elements 31a. Hence, the light-guiding unit 3a is positioned on the PCB 10 of the chip unit 1 via the positioning elements 31a.

Therefore, the beams L1 are reflected via the reflective surface to form first beams L2 that project onto an object surface S, and the first beams L2 are reflected via the object surface S to form second beams L3 that project onto the image-sensing chip 12.

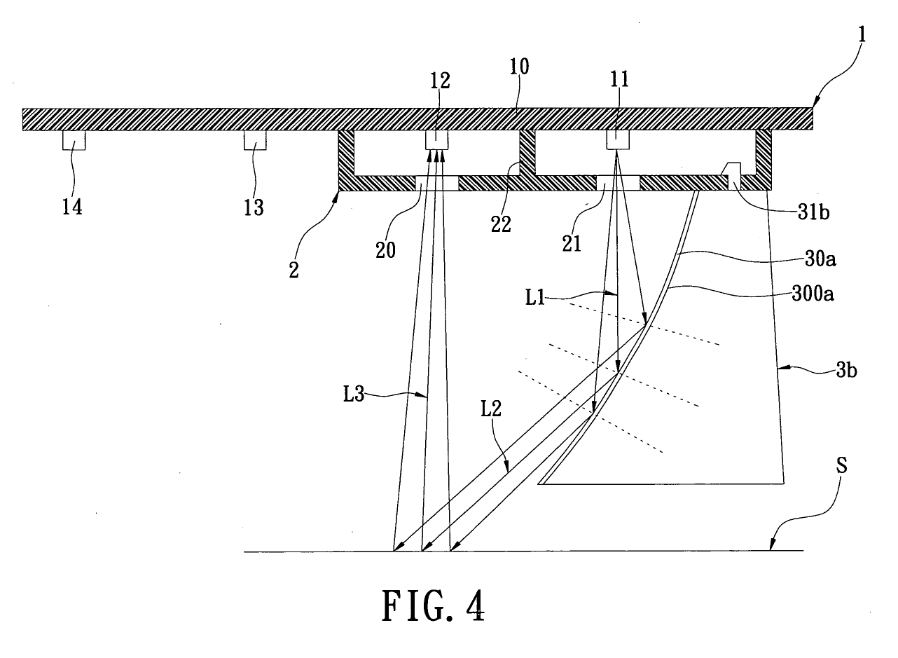

Referring to FIG. 4, the second embodiment of the present invention provides a motion-detecting module with a built-in light source. The difference between the second embodiment and the first embodiment is that the motion-detecting module has a light-guiding unit 3b. Moreover, the light-guiding unit 3b has a plurality of positioning elements 31b. Hence, the light-guiding unit 3b is positioned on the cover unit 2 via the positioning elements 31b.

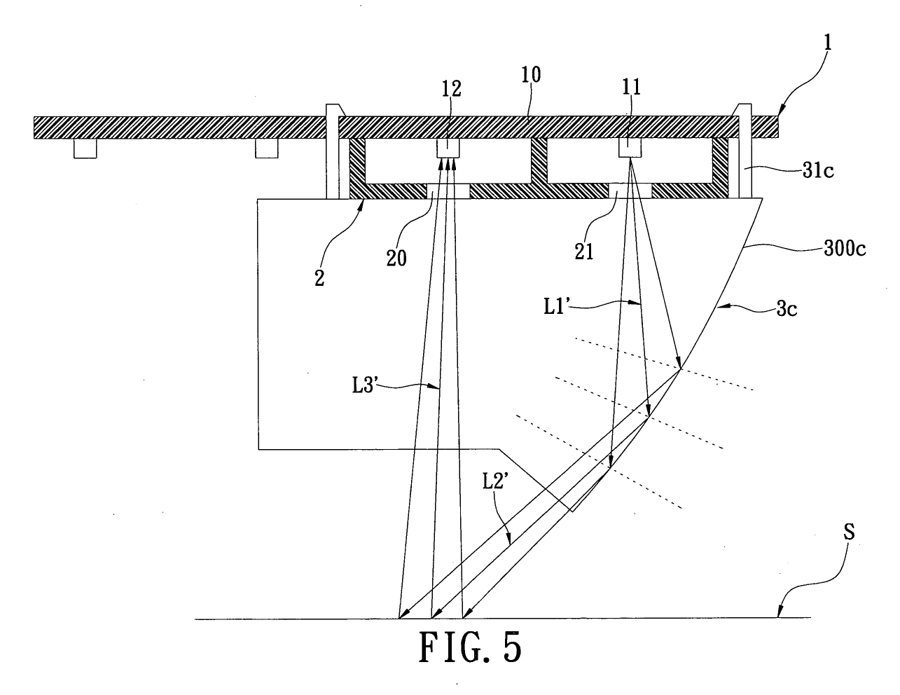

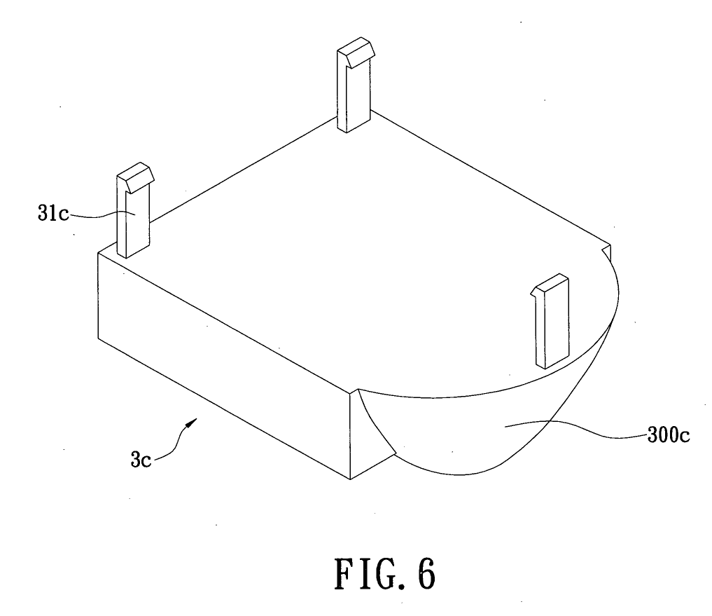

Referring to FIGS. 5 and 6, the third embodiment of the present invention provides a motion-detecting module with a built-in light source. The difference between the third embodiment and the first embodiment is that the motion-detecting module has a light-guiding unit 3c, which is a total internal reflection type light-guiding element. Moreover, the light-guiding unit 3c has a reflective surface 300c for reflecting and condensing beams L1′ that generate from the light-emitting chip 11. The total internal reflection type light-guiding element has a refractive index higher than that of air. The surface 300a is a concave structure. According to different requirements, the surface 300a can be a spherical surface, an aspherical surface, a paraboloid, a hyperboloid, or an ellipsoid. Furthermore, the light-guiding unit 3c has a plurality of positioning elements 31c. Hence, the light-guiding unit 3c is positioned on the PCB 10 of the chip unit 1 via the positioning elements 31c.

Therefore, the beams L1′ are reflected via the reflective surface 300c to form first beams L2′ that project onto an object surface S, and the first beams L2′ are reflected via the object surface S to form second beams L3′ that project onto the image-sensing chip 12.

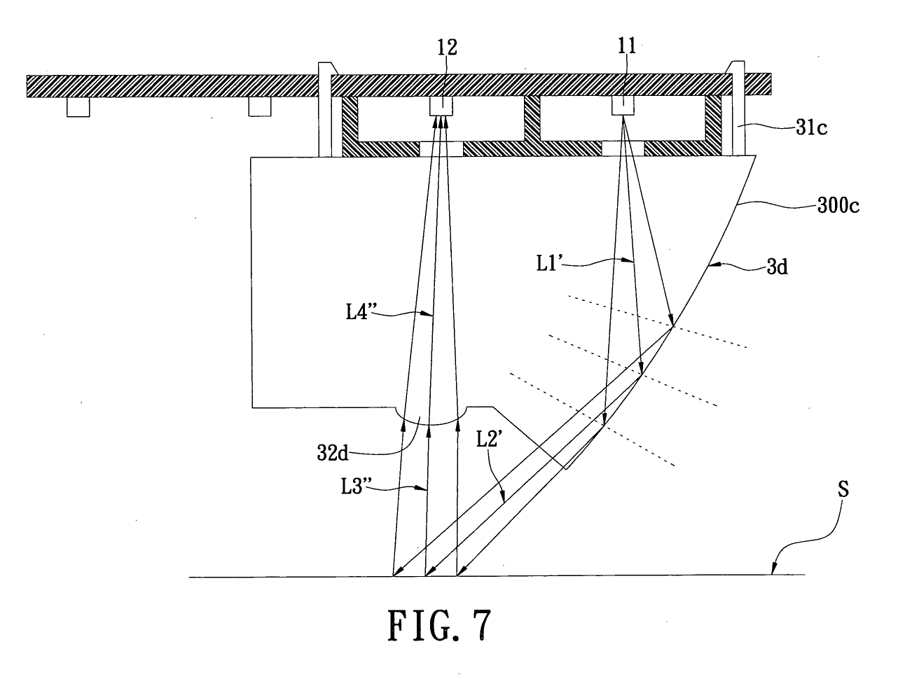

Referring to FIG. 7, the fourth embodiment of the present invention provides a motion-detecting module with a built-in light source. The difference between the fourth embodiment and the third embodiment is that the motion-detecting module has a light-guiding unit 3d. Moreover, the light-guiding unit 3d has a convex lens 32d correspondingly disposed under the image-sensing chip 12 for formation of image. The light-guiding unit 3d is a total internal reflection type light-guiding element. Therefore, the beams L1′ are reflected via the reflective surface 300c to form first beams L2′ that project onto an object surface S, the first beams L2′ are reflected via the object surface S to form second beams L3″ that project onto the convex lens 32d, and the second beams L3″ are condensed via the convex lens 32d to form condensing beams L4″ that project onto the image-sensing chip 12 finally.

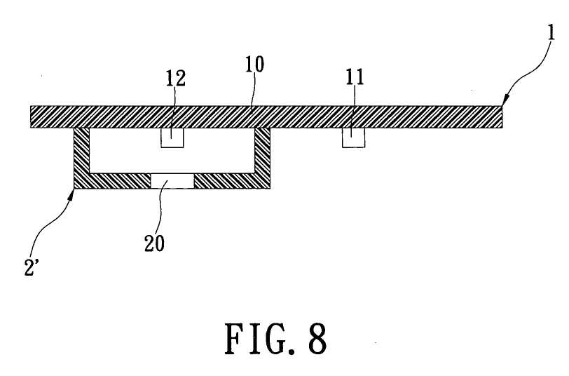

FIG. 8 shows a cross-sectional, schematic view of another cover unit of the present invention. The cover unit 2′ is only covered on the image-sensing chip 12, and the cover unit 2′ only has a first opening 20 for exposing the image-sensing chip 12. In other words, the cover unit 2′ does not be covered on the light-emitting chip 11.

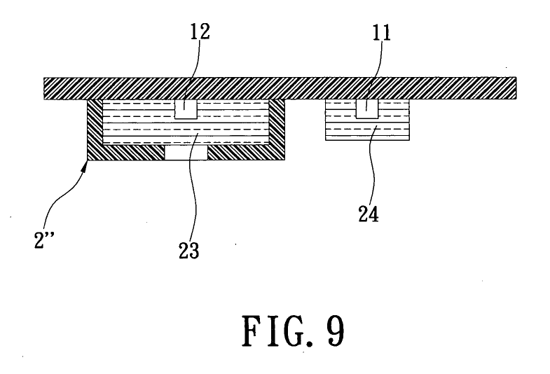

FIG. 9 shows a cross-sectional, schematic view of another cover unit of the present invention. The difference between a cover unit 2″ of the FIG. 9 and the cover unit 2′ of FIG. 8 is that the cover unit 2″ has a first transparent package body 23 for covering the image-sensing chip 12 and a second transparent package body 24 for covering the light-emitting chip 11. Both the first transparent package body 23 and the second transparent package body 24 are made of an epoxy material.

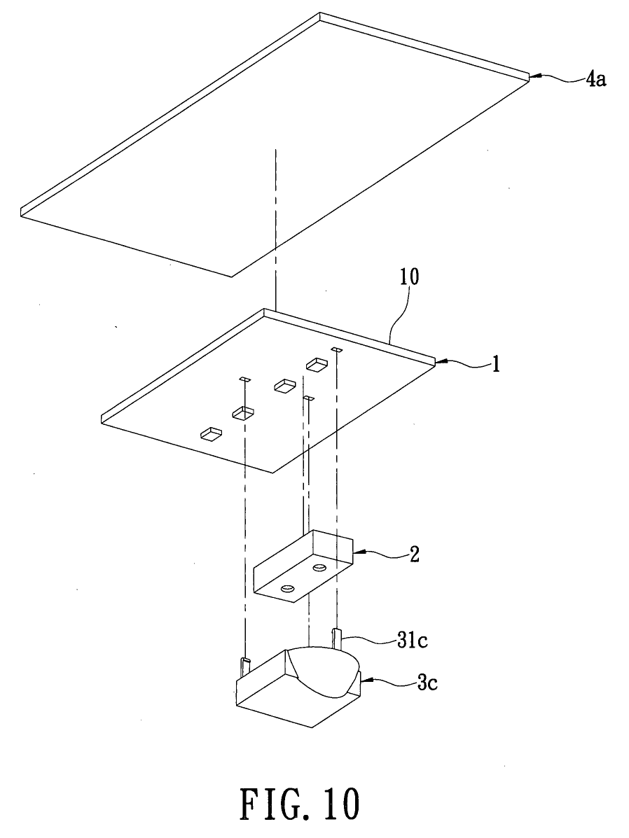

FIG. 10 shows an explode, schematic view of a first conductive connection method between a chip unit and a main PCB according to the present invention. In the first conductive connection method, the motion-detecting module further comprises a main PCB 4a for electrically connecting with the chip unit 1. Moreover, the chip unit 1 is electrically connected with the main PCB 4a via a SMT (Surface Mounting Technology) method. The same as the FIG. 6, the light-guiding unit 3c has a plurality of positioning elements 31c. Hence, the light-guiding unit 3c is positioned on the PCB 10 of the chip unit 1 via the positioning elements 31c.

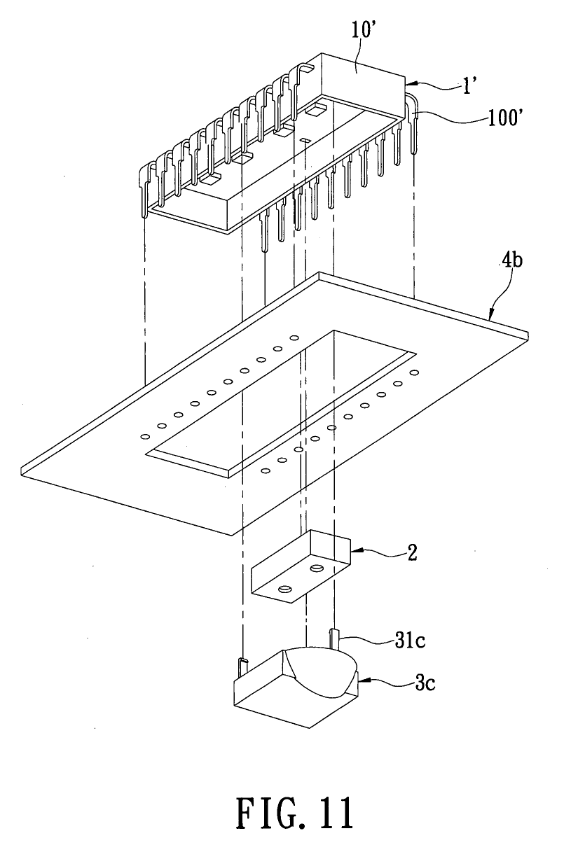

FIG. 11 shows an explode, schematic view of a second conductive connection method between a chip unit and a main PCB according to the present invention. In the second conductive connection method, the motion-detecting module further comprises a main PCB 4b for electrically connecting with the chip unit 1′. Moreover, the chip unit 1′ is electrically connected with the main PCB 4b via a plurality of pins 100′ of a lead frame 10′. The same as the FIG. 6, the light-guiding unit 3c has a plurality of positioning elements 31c. Hence, the light-guiding unit 3c is positioned on the lead frame 10′ of the chip unit 1′ via the positioning elements 31c.

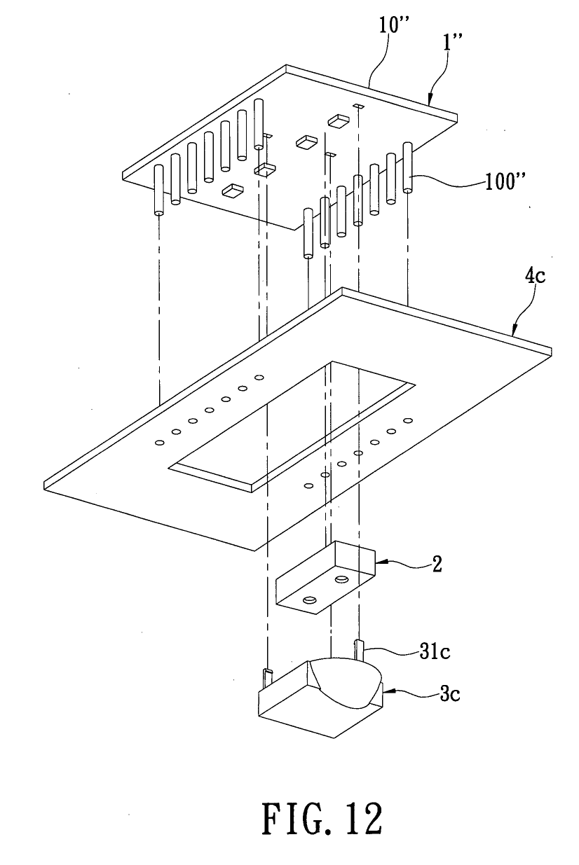

FIG. 12 shows an explode, schematic view of a third conductive connection method between a chip unit and a main PCB according to the present invention. In the third conductive connection method, the motion-detecting module further comprises a main PCB 4c for electrically connecting with the chip unit 1″. Moreover, the chip unit 1″ is electrically connected with the main PCB 4c via a plurality of implanted pins 100″. The same as the FIG. 6, the light-guiding unit 3c has a plurality of positioning elements 31c. Hence, the light-guiding unit 3c is positioned on the PCB 10″ of the chip unit 1″ via the positioning elements 31c.

In conclusion, the light-emitting chip 11 and the image-sensing chip 12 are separately embedded in the same PCB 10 and the present invention uses the reflection type light-guiding element or the total internal reflection type light-guiding element (such as light-guiding unit 3a, 3b, 3c, 3d) for guiding beams (such as beams L1, L1′) from the light-emitting chip 11 to the image-sensing chip 12, so that the manufacturing cost is reduced and the assembling yield is increased in the present invention.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A motion-detecting module with a built-in light source, comprising:
a chip unit having a PCB (Printed Circuit Board), a light-emitting chip, and an image-sensing chip, wherein both the light-emitting chip and the image-sensing chip are electrically disposed on the PCB, respectively and the light-emitting chip generates beams;
a cover unit covered on the image-sensing chip, wherein the cover unit has a first opening for exposing the image-sensing chip; and
a light-guiding unit disposed on a bottom side of the cover unit, wherein the light-guiding unit has a reflective layer on an surface thereof to form a reflective surface for reflecting and condensing the beams that generate from the light-emitting chip to form first beams;
Whereby, the first beams are reflected from the reflective surface of light-guiding unit to project onto an object surface and are reflected by the object surface to form second beams, and the second beams are reflected from the object surface to project onto the image-sensing chip.

2. The motion-detecting module as claimed in claim 1, wherein the chip unit has a motion calculator ASIC (Application Specific Integrated Circuit) and an interfacing MCU (Microprocessor Control Unit) for communicating with external systems, and both the motion calculator ASIC and the interfacing MCU are electrically disposed on the PCB.

3. The motion-detecting module as claimed in claim 1, further comprising a main PCB for electrically connecting with the chip unit.

4. The motion-detecting module as claimed in claim 3, wherein the chip unit is electrically connected with the main PCB via a SMT (Surface Mounting Technology) method.

5. The motion-detecting module as claimed in claim 3, wherein the chip unit is electrically connected with the main PCB via a plurality of pins of a lead frame.

6. The motion-detecting module as claimed in claim 3, wherein the chip unit is electrically connected with the main PCB via a plurality of implanted pins.

7. The motion-detecting module as claimed in claim 1, wherein the cover unit is covered on the light-emitting chip, and the cover unit has a second opening for exposing the light-emitting chip.

8. The motion-detecting module as claimed in claim 1, wherein the cover unit has a partition for dividing the light-emitting chip from the image-sensing chip.

9. The motion-detecting module as claimed in claim 1, wherein the cover unit is positioned on the PCB of the chip unit.

10. The motion-detecting module as claimed in claim 1, wherein the cover unit has a first transparent package body for covering the image-sensing chip and a second transparent package body for covering the light-emitting chip.

11. The motion-detecting module as claimed in claim 1, wherein the light-guiding unit is a reflection type light-guiding element, and the reflective layer is a reflective material that is coated or pasted on the surface of the light-guiding unit.

12. The motion-detecting module as claimed in claim 11, wherein the reflective surface is a concave structure.

13. The motion-detecting module as claimed in claim 12, wherein the reflective surface is a spherical surface, an aspherical surface, a paraboloid, a hyperboloid, or an ellipsoid.

14. The motion-detecting module as claimed in claim 1, wherein the light-guiding unit is positioned on the PCB of the chip unit.

15. A motion-detecting module with a built-in light source, comprising:
a chip unit having a PCB (Printed Circuit Board), a light-emitting chip, and an image-sensing chip, wherein both the light-emitting chip and the image-sensing chip are electrically disposed on the PCB, respectively;
a cover unit covered on the image-sensing chip, wherein the cover unit has a first opening for exposing the image-sensing chip; and
a light-guiding unit disposed on a bottom side of the cover unit, wherein the light-guiding unit has a total reflective surface for reflecting and condensing beams that generate from the light-emitting chip;
Whereby, first beams reflected from the reflective surface of light-guiding unit are generated to project onto an object surface, and the second beams reflected from the object surface are generated to project onto the image-sensing chip.

16. The motion-detecting module as claimed in claim 15, wherein the chip unit has a motion calculator ASIC (Application Specific Integrated Circuit) and an interfacing MCU (Microprocessor Control Unit) for communicating with external systems, and both the motion calculator ASIC and the interfacing MCU are electrically disposed on the PCB.

17. The motion-detecting module as claimed in claim 15, further comprising a main PCB for electrically connecting with the chip unit.

18. The motion-detecting module as claimed in claim 17, wherein the chip unit is electrically connected with the main PCB via a SMT (Surface Mounting Technology) method.

19. The motion-detecting module as claimed in claim 17, wherein the chip unit is electrically connected with the main PCB via a plurality of pins of a lead frame.

20. The motion-detecting module as claimed in claim 17, wherein the chip unit is electrically connected with the main PCB via a plurality of implanted pins.

21. The motion-detecting module as claimed in claim 15, wherein the cover unit is covered on the light-emitting chip, and the cover unit has a second opening for exposing the light-emitting chip.

22. The motion-detecting module as claimed in claim 15, wherein the cover unit has a partition for dividing the light-emitting chip from the image-sensing chip.

23. The motion-detecting module as claimed in claim 15, wherein the cover unit is positioned on the PCB of the chip unit.

24. The motion-detecting module as claimed in claim 15, wherein the cover unit has a first transparent package body for covering the image-sensing chip and a second transparent package body for covering the light-emitting chip.

25. The motion-detecting module as claimed in claim 15, wherein the light-guiding unit is a total internal reflection type light-guiding element, and a refractive index of the total internal reflection type light-guiding element is higher than that of air.

26. The motion-detecting module as claimed in claim 15, wherein the reflective surface is a concave structure.

27. The motion-detecting module as claimed in claim 26, wherein the reflective surface is a spherical surface, an aspherical surface, a paraboloid, a hyperboloid, or an ellipsoid.

28. The motion-detecting module as claimed in claim 15, wherein the light-guiding unit has a convex lens correspondingly disposed under the image-sensing chip for formation of image

29. The motion-detecting module as claimed in claim 15, wherein the light-guiding unit is positioned on the PCB of the chip unit.
